(19) United States
(12) Patent Application Publication
(10) Pub. No.: US 2007/0089831 A1
(43) Pub. Date: Apr. 26, 2007

(54) Card with hologram formed over magnetic strip

(76) Inventors: Celerino Florentino, South River, NJ (US); John Herslow, Scotch Plains, NJ (US)

Correspondence Address: HENRY I. SCHANZER, ESQ, 29 BROOKFALL RD., EDISON, NJ, 08817, US

(21) Appl. No.: 11/581,240

(22) Filed: Oct. 16, 2006

Related U.S. Application Data
(60) Provisional application No. 60/727,355, filed on Oct. 17, 2005.

(51) Int. Cl. B32B 37/00; G06K 7/10

(52) U.S. Cl. 156/272.4; 235/457

(57) ABSTRACT

A first subassembly is formed with a magnetic stripe and a second subassembly is formed, independently of the first subassembly, with an imaging (holographic) layer. The second subassembly may bonded to the first subassembly by means of a heat activated suited to adhere to the two subassemblies to form an assembly in which an imaging layer overlies a magnetic stripe. Forming the two subassemblies independently of each other enables each subassembly to be formed so as to optimize the components and functions of each subassembly. The second assembly may include a transparent top layer which is scratch and abrasion resistant to protect the underlying imaging layer which may include an embossed layer overlying either a metallic layer or a coating having a high refractive index.

### This application claims priority based on Provisional Application Ser. No. 60/727,355 filed Oct. 17, 2005, the contents of which are incorporated herein by reference.

### BACKGROUND OF THE INVENTION

This invention relates to mounting a hologram over a magnetic strip. As is known in the art a magnetic strip is normally attached to one side (e.g., the back side) of a card. For increasing the security of the card a hologram (e.g., a diffraction grating forming an image) is formed on a surface of the card. The spaces available on the front of a card are very limited. Issuers of cards desire to use the available space for imparting commercial information, identifying themselves, and/or the holder of the card. Due to space constraints it is desirable to form a hologram over the magnetic strip area.

Such use has been suggested in U.S. Pat. No. 4,684,795 titled Security Tape With Integrated Hologram And Magnetic Strip issued to G. Colgate, Jr. on Aug. 4, 1987. A problem with known schemes is that the suggestion is to form a hologram over an existing magnetic area. The requirement (chemical and structural) of forming the hologram and enabling it to adhere to the surface of the magnetic strip have a deleterious effect on the magnetic properties of the magnetic strip. As a result, there is no known simple and economic solution for producing a hologram over a magnetic strip.

Applicants have discovered apparatus and a method for forming a hologram-over a magnetic strip in an elegantly novel manner which is relatively simple, reliable and economic.

### SUMMARY OF THE INVENTION

In accordance with one embodiment of the invention, a first subassembly is formed with a magnetic stripe and a second subassembly is formed, independently of the first subassembly, with an imaging (holographic) layer. Forming the two subassemblies independently of each other enables each subassembly to be formed so as to optimize the components and functions of each subassembly. The second subassembly is then bonded to the first subassembly to form an assembly in which an imaging layer overlies a magnetic stripe. The two subassemblies may be bonded together by means of an adhesive which is suited to adhere to the first subassembly and to the second subassembly.

In accordance with the invention there is formed a top layer over the imaging layer which is transparent and “hard” in order to protect the underlying imaging layer over a wide range of conditions. The imaging layer may include an embossed layer, which may be selectively colored, overlying either a metallic layer or a coating having a high refractive index to produce a hologram and/or an image pattern similar to that produced by a hologram.

### BRIEF DESCRIPTION OF THE DRAWINGS

In the accompanying drawings like reference characters denote like components; and

FIG. 1A is a cross sectional diagram of a subassembly (“A”) which includes a magnetic stripe for use in practicing the invention;

FIG. 1B is a simplified cross sectional diagram of a subassembly (“B”) which includes a holographic (imaging) layer for use in practicing the invention;

FIG. 1C is a cross sectional diagram of subassembly B attached to subassembly A to form an assembly with a hologram overlying a magnetic stripe, in accordance with the invention;

FIGS. 1D1 and 1D2 illustrate, respectively, that the imaging layer may be formed to include an embossing layer overlying either a metallic layer or a high refractive index coating;

FIG. 1E is a more detailed cross sectional diagram of a holograph containing subassembly formed in accordance with the invention;

FIG. 1F is a cross sectional diagram of the magnetic stripe and holographic subassemblies bonded together to form an assembly in accordance with the invention; and

FIG. 2 is a flow chart illustrating a process for forming a subassembly containing an imaging layer, in accordance with the invention.

### DETAILED DESCRIPTION OF THE INVENTION

As already noted, cards formed in accordance with the invention and their method of manufacture include forming two subassemblies independently of each other. One subassembly is formed to include a magnetic stripe or medium and the other subassembly is formed to include a hologram or an imaging pattern akin to a hologram. Forming the two subassemblies independently of each other enables the components and functions of each subassembly to be optimized without concern for its effect on the other subassembly. The two subassemblies can then be bonded together such that the hologram and/or image pattern overlies the magnetic stripe. Bonding may be achieved using a particular adhesive which adheres well to the two subassemblies.

In accordance with the invention, a subassembly containing magnetic medium may be mounted onto a substrate (PVC card stock) and a subassembly containing a hologram may be mounted over the magnetic medium. A feature of the invention includes the use of a particular adhesive to cause the holographic material to adhere to the top surface of the magnetic medium. Another feature of the invention is the nature of a top layer formed over the imaging layer (e.g., hologram or like pattern producing material) which protects the underlying imaging layer over a wide range of conditions and enables the assembly and cards made therefrom to have extended life.

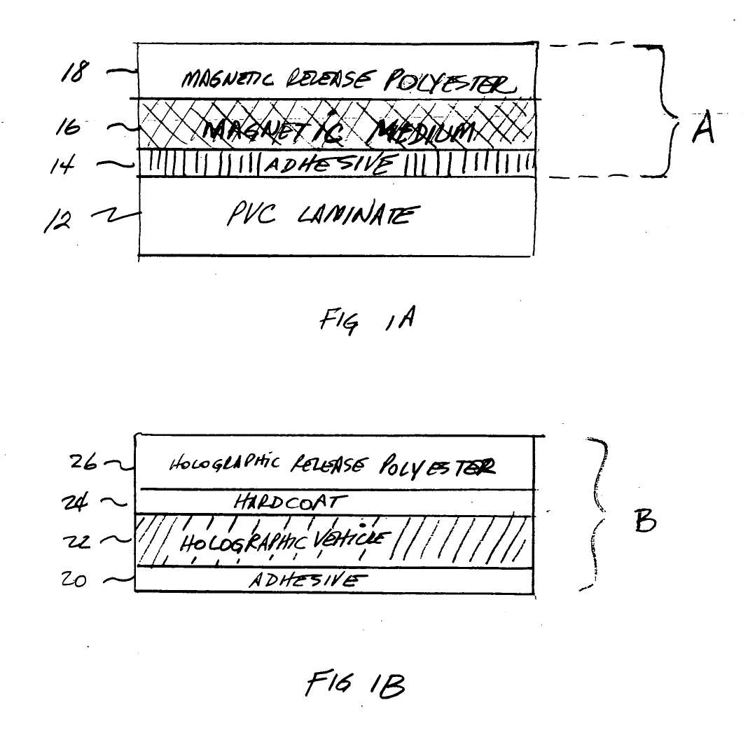

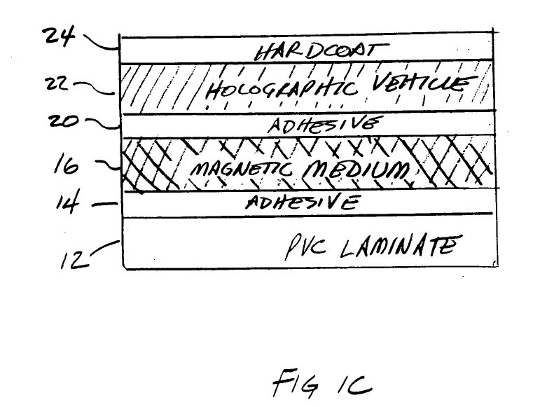

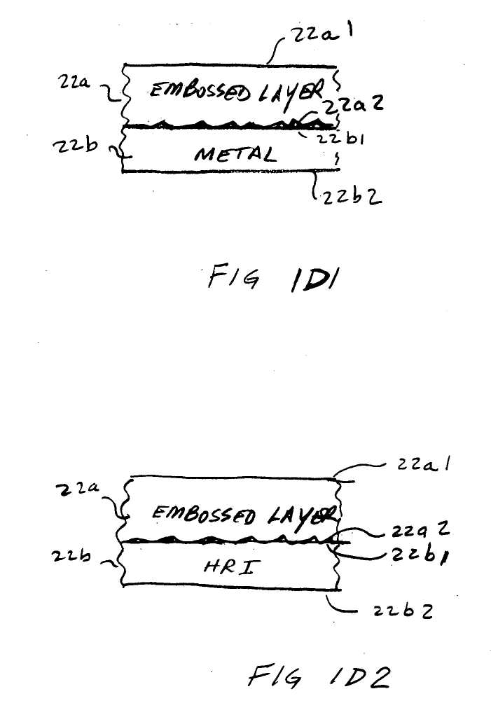

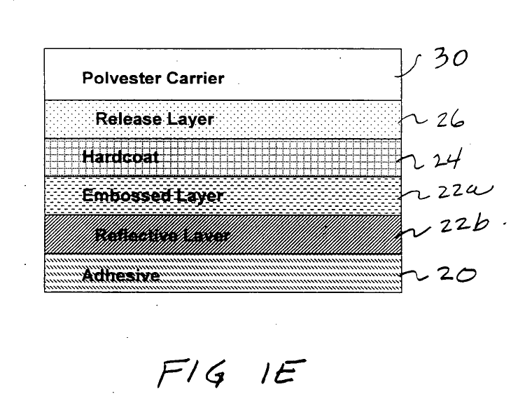

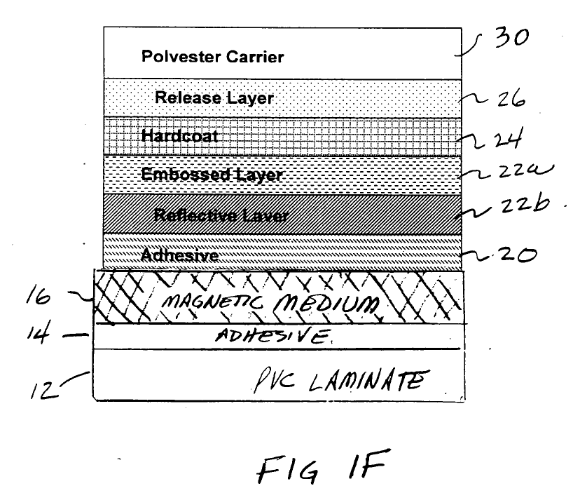

FIG. 1A illustrates the formation of a subassembly A which includes a magnetic stripe. FIG. 1A shows a PVC laminate 12, on top of which is an adhesive layer 14, above which is mounted a magnetic medium 16, on top of which is a magnetic release polyester layer 18. The adhesive layer 14, the magnetic medium/layer 16 and the magnetic release polyester layer 18 may be preformed and assembled as part of a separate sub assembly “A” on a carrier (not shown) which is applied to PVC laminate or substrate 12. That is, subassembly A is transferred onto substrate 12. After the subassembly is transferred, the layer 18 is removed leaving the magnetic medium (stripe) firmly attached via the adhesive layer to the PVC substrate 12. This is shown in FIG. 1C where layers 16 and 14 are shown on top of substrate 12 (and layer 18 is no longer present). Forming the magnetic medium/stripe independently of any other assembly enables the manufacture of a “magnetic” subassembly in which the magnetic component(s) and their function(s) need not be compromised to accommodate those of any other subassembly.

FIG. 1B shows the formation of a sub-assembly “B” which includes a “holographic vehicle”. As used herein and in the appended claims the holographic vehicle or layer 22 is intended to include any hologram as well as any image forming layer producing an optical image (not necessarily a hologram) in response to incident light.

Subassembly B is formed on its won carrier independently of the magnetic subassembly. The holographic sub-assembly B includes an adhesive layer 20, a holographic vehicle (containing a hologram or optical image producing material) layer 22, over which is formed a hard coat (protective) 24 on top of which is the holographic release polyester layer 26.

The holographic subassembly B may be transferred and bonded onto an underlying magnetic subassembly A leaving the assembly/sandwich shown in FIG. 1C. In FIG. 1C the magnetic release layer 18 was removed prior to bonding subassembly B to subassembly A and the holographic release polyester layer 26 was released concurrently with the bonding of the two subassemblies. Thus, the assembly includes the PVC laminate layer 12, to which is attached the magnetic medium 16 by means of the adhesive layer 14 over which is attached the holographic vehicle 22 by means of adhesive layer 20. The holographic layer is protected by hard coat layer 24.

Forming the magnetic assembly and the holographic assembly as separate sub-assemblies and then transferring the sub-assemblies onto a common substrate, with the sub-assemblies attached one above the other, enables the formation of a magnetic strip which is not significantly altered by the subsequent attachment of the holographic layer. That is, transferring the hologram over the magnetic strip in the manner taught herein does not have any significant deleterious effects on the magnetic properties of the magnetic strip while enabling the hologram and the magnetic strip to be firmly and securely bonded to each other. Each subassembly can be processed an formed to enhance its function without being affected by the processing steps needed to form any other subassembly.

The PVC laminate may be mounted and attached to stock card material (e.g., credit card sheet) in any known manner. The thickness of the release layers (18, 26) may range from ¼ of a mil to 1 mil or more. The thickness of the magnetic medium may also vary over a wide range (e.g., ¼″ mil to more than 1 mil). The thickness of the adhesive layers (14, 20) may vary over a considerable range (e.g., 0.05 to more than 0.1 mil). The hard coat layer 24 and the holographic layer with holographic embossing may each vary over a considerable range, but generally each being less than 1 mil (e.g., 0.05 to 0.1 mil).

FIG. 1D1 illustrates that the holographic layer 22 may include an embossing layer 22a formed over a layer of metal (e.g., aluminum) 22b. The embossing layer may be a resinous material with an image formed at the interface between the bottom surface 22a2 of the embossing layer 22a and the top surface 22b1 of the metal layer 22b. This construction would typically be used to form a hologram.

FIG. 1D2 illustrates that the “holographic vehicle” 22 may include an embossing layer 22a formed over a high refractive index (HRI) coating 222b, such as zinc sulfide layer. As in FIG. 1D1, the embossing layer 22a may be a resinous material with an image formed at the interface between the bottom surface 22a2 of the embossing layer 22a and the top surface 222b1 of HRI layer 222b.

Inventive features and details of subassembly B, as formed in accordance with the invention, are discussed below.

The hard coat layer (24 or 24a) is a high transparency, low viscosity Hexandioldiacrylate (HDDA) monomer with a high loading of non-agglomerated spherical silica nanoparticles. In one embodiment, the nanoparticles had diameters in the range of 20 nm and were distributed homogenously within the hard coat layer (24, 24a). They significantly improve the scratch and abrasion resistance of the cured coating without loss in transparency, while the polymerized acrylate creates a thermoset coating that has superior chemical resistance. Use of nanoparticles over conventional larger-sized fillers eliminates sedimentation, so the coating property of the solution is much better suited to thin film gravure coating. This layer is generally cured by the application of ultraviolet (UV) energy.

Advantages offered by this type of hard coat layer as formed and cured over traditional gravure coatings include:

no reduction in transparency despite high filler content

reduction of shrinkage of physical parameters upon cure

reduced thermal expansion and internal coating stresses

barrier against gases, water vapor and solvents

increased weather resistance

superior scratch and abrasion resistance

increased tear resistance and fracture toughness.

The adhesive coating/layer 20 may be a heat activated composite layer/coating, consisting of a vinyl acetate primer compound and an ethylene/vinyl acetate polyketone copolymer. The vinyl acetate primer compound provides adhesion to the bottom surface (22b2, 222b2) of the metal layer (22b) or the high refractive index coating (222b), while the second component of the adhesive provides the adhesion to the top surface of the magnetic stripe/medium 16.

A subassembly (“B”) containing the image (holographic) layer may be formed as shown in FIG. 1E. The base of the subassembly may be a clear polyester film carrier 30 whose thickness may vary over a very wide range (e.g., from approximately ½ mil to more than a 1 mil).

A release layer 26 is formed on the carrier 30. The release layer 26 can be a wax-based coating, or an acrylate or polyurethane coating that releases from the polyester film carrier when heat is applied. This layer allows all of the other coatings to separate from the film carrier in the application process.

As above, a hardcoat or topcoat 24 may be formed over the release layer 26. The hard coat layer 24 may be a polyurethane oligomer polyacrylate coating that is cured with ultraviolet (UV) light in the coating process. A photoinitiator may be added to this coating 24 to render it more curable to the UV light. As discussed above, this polyurethane oligomer polyacrylate coating contains non-agglomerated, spherical silica nanoparticles and unsaturated methyl-methacrylates that increase the surface hardness of the coating and also increases the scratch and abrasion resistance of the coating without decreasing transparency which is needed in this holographic application.

Over the hardcoat 24 there is formed an embossed coating 22a. The embossed coating 22a may be, also, a polyurethane oligomer polyacrylate (a resinous) coating that is cured with ultraviolet light in the coating process. This coating also goes through the UV curing process but is not totally cured to allow it to accept embossing of a holographic image to its surface. That is, layer 22a may be partially cured to allow the formation of a hologram or optical image at the interface between the embossed layer 22a and the reflective layer 22b (which may be a metal or HRI layer). Subsequently, the layer 22a would be fully cured. This layer 22a of the coating may also contain transparent colorants so that when metallized, these colorants impart a metallic color appearance, such as metallic red, or metallic blue, or whatever color is desired.

Overlying the embossed layer is a reflective layer 22b. As already noted, The reflective layer 22b for finalizing the formation of the optical image on and within subassembly B may include either a vacuum deposited layer of aluminum to form a hologram or a high refractive index (HRI) coating such as zinc sulfide, or zinc oxide.

Overlying the reflective layer 22b is an adhesive layer 20. The adhesive layer 20 may be a heat activated composite layer, consisting of a vinyl acetate primer compound and an ethylene/vinyl acetate polyketone copolymer. After the adhesive layer is applied the subassembly “B” is then attached to the magnetic medium subassembly as shown in FIG. 1F.

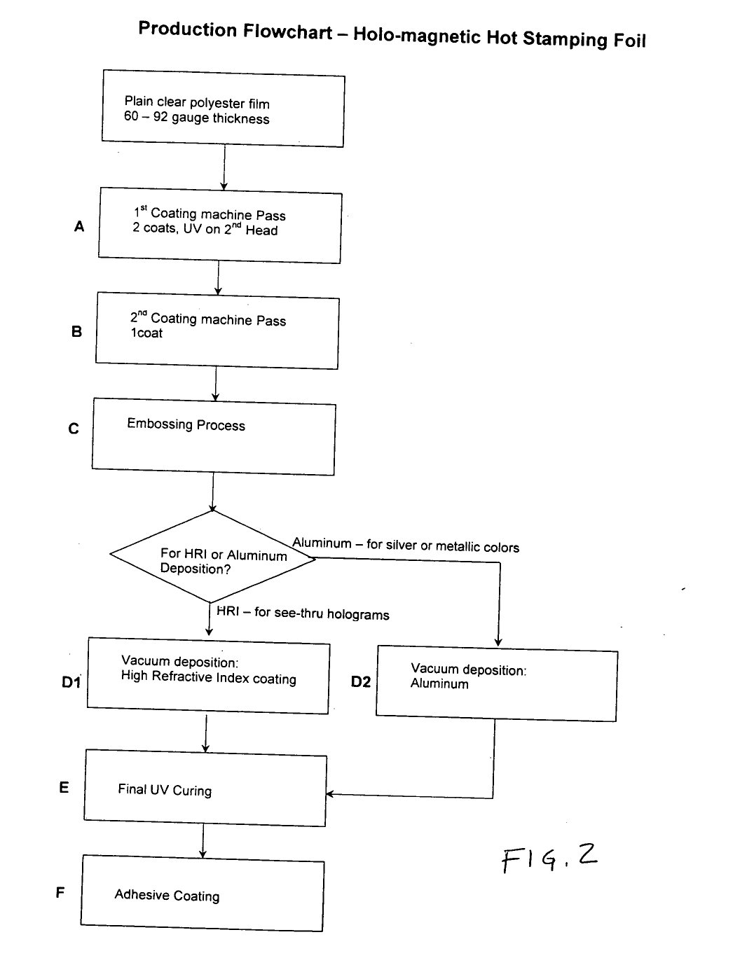

Various process steps in forming a subassembly “B” in accordance with the invention are discussed below, as illustrated in FIG. 2.
A—The coating of the polyester carrier 30 with the various release layer and hardcoat coatings may include doing the process using a 3-head gravure coating machine, applied in-line on to clear polyester film 30. A first (release) coat 26 is a thin layer of wax coating which allows all the subsequent coatings to be released from the polyester film carrier during a subsequent hot stamping process (when the subassemblies are bonded to each other). The hard coat 24 is then formed on top of release layer 26. The hardcoat 24a includes a UV-cured polyurethane oligomer polyacrylate coating containing non-agglomerated spherical silica nanoparticles and unsaturated methyl-methacrylates. The coat 24 is referred to as a “hard” coat because it imparts surface hardness, increasing the scratch and abrasion resistance of the foil without decreasing transparency. Each of the coating may be applied using a separate coating head. After each coating is applied, the coated web goes into a drying tunnel where the coating is dried before the next coating is applied. After the coatings (26, 24) are applied, the combined coatings go through a UV-curing station which cures the hardcoat layer 24.
B—The embossing layer 22a may be applied to the hardcoat layer using a gravure coating machine. The embossing layer/coating 22a may be a polyurethane oligomer polyacrylate. After the coating 22a is applied over the previous coatings (24, 26a), it is partially cured in a UV-curing station. Partial curing of this thermosetting coating allows it to be embossed with a holographic image on its (exposed) surface 22a2. This coating 22a may also include transparent colorants that would impart a colored metallic appearance after aluminum deposition.

In accordance with the invention, FIG. 2 illustrates that an optical image (e.g., a hologram) may be formed on and within the resinous layer 22a at its interface with reflective layer 22b.
C—The embossing process may be completed by using heat and pressure to transfer an optical image (e.g., hologram) from a nickel shim onto the embossable coating surface (e.g., 22a2) in the step described above. The embossed optical image may be enhanced in either one of at least the two ways describe below:
D1—A layer of aluminum may be coated onto the exposed surface 22a2 of the resinous layer 22a to form a hologram by vacuum deposition. This process may be done in a vacuum deposition chamber. A thin layer of aluminum about 400-800 Angstroms thick is applied over the embossed layer 22a. In contrast to the high refractive index coating (see below), this coating of aluminum will cause the holographic film to be (or appear to be) opaque. This also gives a more visible and vibrant holographic effect to the finished product.
D2—Alternatively, the optical image may be may be formed by vacuum deposition of a High Refractive Index Coating 22b. This process may also be done in a vacuum deposition chamber. A thin layer of a transparent, high refractive material, such as zinc sulfide, may be deposited on the exposed surface 22a2 of embossed layer 22a. This coating allows the optical image to be visible after application onto a substrate without totally obscuring the material over which the hot stamping foil is applied.
E—Final UV Curing—After the embossing process, the coatings are again put through a UV-curing process to fully cure the coatings. This creates a thermoset coating that has superior physical and chemical resistance properties.
F—Adhesive coating 20—This is the final coating process where an adhesive is applied onto the previous layers. This is a heat activated ethylene/vinyl acetate polyketone copolymer developed primarily to adhere to magnetic stripe material onto which the subassembly B is to be mounted.

The above examples are by way of illustration and it should be evident that the invention may be practiced in many different ways.

What is claimed is:

1. A combination comprising:
a first subassembly formed to include a magnetic medium layer;
a second subassembly formed to include an imaging layer, said second subassembly formed independently of the first subassembly; and
an adhesive coating suited to adhere to said first and second subassemblies for bonding said first and second subassemblies to form an assembly in which the imaging layer overlies the magnetic medium layer.

2. A combination as claimed in claim 1, wherein said second subassembly includes a transparent top layer of a scratch and abrasion resistant material formed over the imaging, wherein the imaging layer contains a hologram, said imaging layer being bonded to said magnetic medium layer.

3. A combination as claimed in claim 2, wherein said imaging layer includes an embossing layer overlying one of a metal layer and a layer of a substance having a high refraction index.

4. A combination as claimed in claim 2, wherein said layer of scratch and abrasion resistant material is of high transparency and includes silica nanoparticles.

5. A combination as claimed in claim 4, wherein said layer of scratch and abrasion resistant material can be cured with ultra violet light without loss of transparency.

6. A combination as claimed in claim 3, wherein the embossing layer is formed of a resinous material which is curable by the application of ultraviolet light; and wherein the embossing material is, first, partially cured for enabling the embossing of an image at an interface between the embossing material and said one of said metal layer and said layer having a high refractive index and then fully cured.

7. A combination as claimed in claim 6, wherein colorants are included in the embossing layer.

8. A combination as claimed in claim 3, wherein said imaging layer includes holographic image which is visible through the top layer.

9. A combination as claimed in claim 2, wherein the adhesive coating is a heat activated composite layer for providing adhesion to the magnetic medium of the first subassembly and to the imaging layer.

10. A combination as claimed in claim 1, wherein said first and second subassemblies when bonded together to form an assembly include a substrate over which is formed a magnetic medium layer over which is an imaging layer over which is a transparent top layer of a scratch and abrasion resistant material.

11. A method for forming a hologram over a magnetic stripe comprising the steps of:
forming a first subassembly containing a magnetic stripe;
forming a second subassembly having a layer containing a hologram; said second subassembly being formed independently of the first subassembly; and
bonding the first and second assemblies by applying an adhesive coating between the two subassemblies and causing the adhesive coating to adhere to said first and second subassemblies for bonding said first and second subassemblies to form an assembly in which the imaging layer overlies the magnetic medium layer.

12. A method as claimed in claim 11, wherein the step of forming said second subassembly includes the step of forming a transparent layer of a scratch and resistant material over the hologram.

13. A method as claimed in claim 12, wherein the adhesive for bonding the subassemblies is a heat activated composite layer and the step of bonding the first and second subassemblies includes the application of heat to bond the subassemblies.
